(19) United States
(12) Patent Application Publication
(10) Pub. No.: US 2014/0052619 A1
(43) Pub. Date: Feb. 20, 2014

(54) FINANCIAL TRANSACTION GIFT REGISTRY SYSTEM AND METHODS

(71) Applicants: Carol P. LUTEN, Falls Church, VA (US); Richard L. HATHAWAY, Fairfax, VA (US); Timothy P. BOGAN, Arlington, VA (US)

(72) Inventors: Carol P. LUTEN, Falls Church, VA (US); Richard L. HATHAWAY, Fairfax, VA (US); Timothy P. BOGAN, Arlington, VA (US)

(21) Appl. No.: 13/968,781

(22) Filed: Aug. 16, 2013

Related U.S. Application Data
(60) Provisional application No. 61/684,958, filed on Aug. 20, 2012.

(51) Int. Cl. G06Q 40/00

(52) U.S. Cl. CPC G06Q 40/00
USPC 705/39

(57) ABSTRACT

System and methods are disclosed for generating a gift registry investment account and portfolio for a recipient to celebrate occasions such as weddings, births, graduations, birthdays, retirements, anniversaries, bar/bat mitzvahs, and the like. The system and associated methods provide the recipient account opening capability, on-line financial gift registry capability, automated investor-specific allocated information and advice among a plurality of financial vehicle combinations based on the investor's risk tolerance, donor review of the gift registry options, financial transactional funding of the donor to the account created by the recipient using a broker. A gift fulfillment package is sent to the recipient to announce the funding gift from the donor. The package is based upon the information provided during the opening of the account.

### FIELD OF THE INVENTION

The present invention relates to a gift registry for a financial investment. More particularly, the present invention relates to an on-line gift registry method and system designed to select and fund a financial gift account for a recipient, which is a recipient selected, donor funded financial gift account that is implemented through a brokerage firm, bank or other service firm.

### DESCRIPTION OF THE RELATED ART

Occasions, such as graduations, birthdays, births, weddings and anniversaries, bar/bat mitzvahs, home ownership, retirements and the like, often result in a financial gift in lieu of a physical one. When cash or checks are given to the recipient security risks can arise as cash and checks can be lost or stolen, especially when they are mailed or not presented directly to the recipient. Furthermore, the recipient may be unaware of future investment strategies and opportunities provided to them through a gift of cash or a check, for example, the benefits of financial compounding. The gifting of cash or a check does not provide financial guidance steps to help steer the recipient toward a successful financial future, nor provide an array of investment options that are available to the recipient. As for the donor, the process would allow convenient gift giving with lasting remembrance, and provide security from the risk of lost checks,

### SUMMARY OF THE INVENTION

The disclosed on-line gift registry method and system solves the problems discussed above so the recipient can personally select a financial gift and open an account at a brokerage firm, bank or other service firm. It then allows the donor to fund the specifically desired gift through the brokerage firm, bank or other service firm, and aids in the development of increased customer acquisition. The purpose is to give the recipient the convenience of registering on-line for a gift they would like to receive. This service would provide the recipient the ability to select a gift registry investment portfolio based on their demographics and risk tolerance. It would provide the recipient specific automated information and investment advice in determining the appropriate plurality of financial products to register for namely: stocks, bonds, certificates of deposit (CDs), exchange traded. Binds, mutual funds, money market accounts and the like, or cash. The donor, on the other hand, has the ability to analyze the selected items listed in the gift registry and compare their associated costs. The disclosed on-line financial gift registry ultimately provides convenience, choice, financial literacy and security for the recipient and donor. The disclosed registry also provides increased customer acquisition for the brokerage firm, bank or other service firm.

A problem many companies experience is how to broaden their client base. An on-line financial gift registry program for brokerage firms, banks or other service firms would increase brand recognition, increase awareness of financial gifting by the recipient and the donor for occasions other than the specific occasion they are registering for or funding, and therefore increase customer acquisition by offering financial gifting alternatives.

The disclosed embodiments include a financial transaction gift registry system that allows a recipient to open an on-line financial gift registry account, select the gift options they would like to register for and allows the donor to fund a gift which is listed on the account. If the recipient is a minor or otherwise not legally able to take ownership of the account, then a custodian may open the account on the recipient's behalf.

People (recipients) enjoy receiving gifts and opening packages containing gifts. The gift packages containing material corresponding to the account serve to: 1) commemorate the occasion, 2) remind the recipient of what the donor gave, 3) allow the recipient a contact reference for reviewing and renewing their gift assets from the brokerage firm, bank or other service firm and 4 the excitement of opening a tangible gift, in the same way they would open a gift of fine china or crystal from a domestic retail store. The donor's funding of the tailored gift package fulfills the specific wish choices of the recipient and allows the recipient to physically open a gift from the donor.

Brokerage firms, banks or other service firms would benefit from the increased brand recognition, thus helping to increase their customer base. Therefore, sending a confirmation gift package to the recipient upon completion of the funding fulfills all of the above criteria. The gift package designs highlight the specific gifting occasions. For example, a financial package for a wedding gift would include a design specific to marriage that is different from a package for the birth of a baby. A confirmation package is also less likely to be lost/misplaced. Upon completion, the donor receives an electronic confirmation, and the recipient receives an electronic confirmation, electronic up-dates and a physical gift package. All of the above steps help reduce the risk of loss of the financial gift.

The package and material corresponding to the account of the disclosed embodiments also may serve to market the broker or their services back to the company. A logo, distinctive coloring, or other sort of branding may be prominently displayed on the gift package and gift folders containing material corresponding to the account. This feature allows the recipient further contact information with the brokerage firm, bank or other service firm regarding the new account and continued accounts. Recipients have the appropriate paperwork handy even after the event.

A larger percentage of young people today are having difficulty finding jobs and saving money. The disclosed process encourages the recipient to save money and provides a financial gift beyond the usual check or cash gift. Although the recipient can use the gift for investment purposes, he or she may also choose to keep it in cash or withdraw it. The hopes are that such a gift encourages the recipient to save the financial gift for a subsequent event, such as purchasing a home or retirement.

The disclosed embodiments include a method for using an on-line financial gift registry. The method includes creating an account by a recipient at a brokerage firm, bank or other service firm. The method also includes selecting gift registry options for the account by the recipient. The method also includes verifying and registering the account for the recipient by a broker of the brokerage firm, bank or other service firm. The method also includes viewing the selected gift registry options by a donor. The method also includes completing a financial transaction by the donor and the broker to fund the account based on the selected gift registry options. The method also includes sending a gift fulfillment package to the recipient by the broker. The gift fulfillment package includes a material corresponding to the account.

The disclosed embodiments also include an on-line system for using a financial gift registry. The system includes computing means for creating an account for a recipient at a brokerage firm, bank or other service firm. The system also includes selection means for selecting a gift registry option for the account by the recipient. The system also includes transaction means for verifying and registering the account for the recipient by a broker of the brokerage firm, bank or other service firm. The system also includes display means for viewing the selected gift registry options by a donor. The system also includes transaction processing means for completing a financial transaction by the donor and the broker to fund the account based on the selected gift registry options. This system also includes a gift fulfillment package that includes a material corresponding to the account from the broker.

The disclosed embodiments also include a method for using an on-line financial gift registry. The method includes displaying gift registry options for a plurality of financial instruments for the recipient and the donor. The gift registry options are selected by a recipient. The method also includes funding an account for the recipient based on one of the gift registry options. The method also includes sending a gift fulfillment package for the account to the recipient.

Although donors are not allowed to open an investment account for a recipient unless it is a custodial account for an individual under age eighteen, the recipient working with a broker, banker or other service firm, or individually, can open an account in accordance with applicable laws and regulations. The recipient's investment objectives are strictly the choice of the recipient and the donor is merely funding the recipient's gift choices. Only if the donor transfers an in-kind donation from his personal account to the recipient would the donor be selecting what is purchased for the recipient. Ownership of the account strictly belongs to the recipient.

The donor's role is to fund a gift to a new or existing account for the recipient. The initiation process of opening a new gift registry account can he suggested by the donor to the recipient such as, “Are you aware of a financial gift registry program offered by brokerage firms and banks.” The financial institution would then send an Email with a link to the recipient stating, “You are invited to open an account with us compliments of the donor.” Or the recipient may already have opened a financial gift registry account. The donor and the recipient should not have different investment objectives because the recipient will choose the type of investment account to open or may choose a cash account to which the donor may choose to fund.

The disclosed embodiments, therefore, put forth a system and process that allows a donor to select and fund a gift registry account on behalf of a recipient without the need to meet with a broker or financial institution, but, instead, over a network. The donor funds the account and a gift fulfillment package is sent to the recipient in the form of a traditional gift but signifying a financial transaction. The recipient receives the package to cherish and remind himself/herself of the gift.

### BRIEF DESCRIPTION OF THE DRAWINGS

For a more complete understanding of the present invention and the advantages thereof, reference is now made to the following descriptions taken in connection with the accompanying drawings, in which:

FIG. 1 illustrates a financial transaction gift registry system according to the disclosed embodiments.

FIG. 2 illustrates a flowchart for a financial gift registry service according to the disclosed embodiments.

FIG. 3 illustrates a flowchart for performing donor actions according to the disclosed embodiments.

FIG. 4A illustrates a flowchart for performing recipient/custodian and broker actions according to the disclosed embodiments.

FIG. 4B illustrates a recipient gift registry template form and associated steps according to the disclosed embodiments.

FIG. 5 illustrates a flowchart of account activity and communication according to the disclosed embodiments.

FIG. 6 illustrates a gift fulfillment package showing an example of a cover style according to the disclosed embodiments.

FIG. 7A illustrates an example of a design generated according to the gift registry account according to the disclosed embodiments.

FIG. 7B illustrates an example of a design generated according to the gift registry account according to the disclosed embodiments.

FIG. 7C illustrates an example of a design generated according to the gift registry account according to the disclosed embodiments.

FIG. 7D illustrates an example of a design generated according to the gift registry account according to the disclosed embodiments.

FIG. 7E illustrates an example of a design generated according to the gift registry account according to the disclosed embodiments.

FIG. 7F illustrates an example of a design generated according to the gift registry account according to the disclosed embodiments.

FIG. 7G illustrates an example of a design generated according to the gift registry account according to the disclosed embodiments.

FIG. 7H illustrates an example of a design generated according to the gift registry account according to the disclosed embodiments.

### DETAILED DESCRIPTION OF THE PREFERRED EMBODIMENTS

Reference will now be made in detail to specific embodiments of the present invention. The examples of these embodiments are illustrated in the accompanying drawings. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims. Numerous specific details are set forth in order to provide a thorough understanding of the present invention.

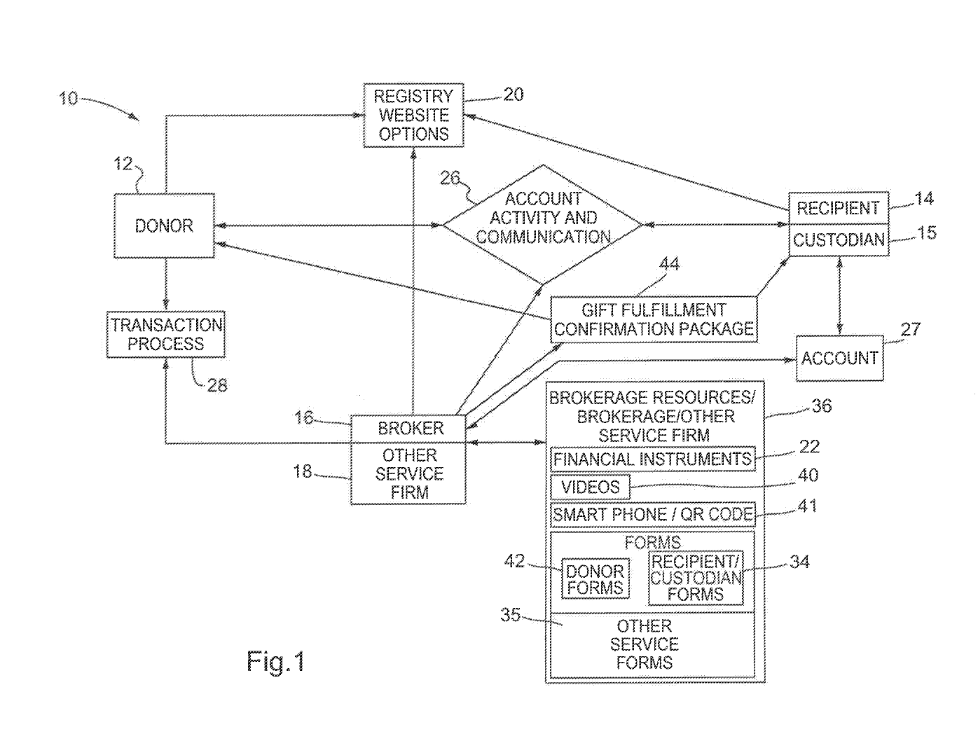

FIG. 1 depicts a financial gift registry system 10 according to the disclosed embodiments. The components of system 10 shown include computers or other processor-enabled devices that allow one to connect with other components within the system. For example, the components may connect over a wireless network using a device that exchanges information over that network. Information generated by actions over system 10 may be stored accordingly on these devices, or in a central location such as a cloud server. Thus, elements labeled as “donor,” “recipient,” and the like refer to a device being used by that entity within system 10. These devices access a network using system 10, such as the Internet, to exchange data with each other, and other components. Preferably, any device used by these entities use an internet protocol (IP) address. An entity, such as the donor, may access the information and the functionality provided by system 10 from any such device, and is not limited to a single device.

Using system 10, a donor 12 may fund an existing investment account on behalf of recipient 14. Donor 12 and recipient 14 may do so in an on-line environment so that donor 12 and recipient 14 do not have to meet personally to exchange the gift. They accomplish these tasks, however, through the use of a broker 16 or other service firm 18. Broker 16 may is refer to a brokerage, bank, investment firm and the like. Other service firm 18 may represent a website or portal that directs one to brokerage services, such as a brokerage website or a gift registry website. The functionality disclosed below pertaining to broker 16 also pertains to other service firm 18, though it may not be explicitly stated. Moreover, other service firm 18 may be referred to as brokerage/life stage portal in the description below.

Broker 16 may be a banker, broker or other professional that maintains the investment account on behalf of recipient 14. To initiate the process of opening an account, recipient 14 contacts broker 16 to set up gift account 27. Other service firm 18 also may refer to an investment, banking or brokerage service having a relationship with a gift registry service. Donor 12 can suggest to recipient 14 the option of opening an on-line gift registry account with a brokerage firm, bank, or other service firm. Broker 16 then may contact recipient 14 with information regarding the opening of gift account 27. If recipient 14 is unable to take ownership due to age or any other issues, then a custodian 15 may do so. Custodian 15 manages the received account on behalf of recipient 14. Hereinafter, when referring to actions taken by recipient 14, the disclosed embodiments also include actions that may be taken by custodian 15 as well in the event recipient 14 is not able to manage his or her affairs.

Recipient 14 creates and donor 12 provides the funds for gift account 27 using the services of broker 16 or other service firm 18. This process is disclosed in greater detail below. Transaction process 28 may refer to the process used to transfer payment from donor 12 into gift account 27. Broker 16 or other service firm 18 may generate the forms electronically needed to create gift account 27.

Website 20 refers to a webpage, application or other computer-implemented interface that shows the gift registry wish list created by recipient 14. Recipient 14 may select from a plurality of financial instruments 22, such as mutual funds, stocks, bonds, certificate of deposits, money market accounts, a cash account and the like, that he or she would like to receive. Recipient 14 may use website 20 to select and display gift registry options based on information available to them or provided by broker 16, as disclosed in greater detail below. Website 20 may provide information to recipient 14 in determining gift registry options. Website 20 may refer recipient 14 to various brokerage resources managed by broker 16.

Brokerage resources 36 provide financial instruments 22 (stocks, certificate of deposits, mutual funds, bonds, and the like), videos 40, donor forms 42, smartphone or QR codes 41 to inform. Brokerage resources also include recipient forms 34 and broker/brokerage firm/bank forms or other service firm forms 35 for opening an account, or any other forms. Other materials may be included as well in brokerage resources 36. Broker 16 or other service firm 18 completes the appropriate broker forms 35 to open gift registry account 27. Preferably, these resources are stored over computer network, or available over the Internet.

Furthermore, recipient 14 may select a list of financial instruments 22 to be made available for website 20, thereby giving donor 12 a selection of investments to fund. Recipient 14 may use a graphical user interface to do so. This information is stored on a computer/database connected to system 10. The selected results may be displayed to users that access website 20. As noted above, each component within system 10 (donor 12, recipient 14/custodian 15, broker 16) includes a computer having a memory and processor. Selections by recipient 14 are stored at broker 16 or other service firm 18, but accessible by recipient 14 any time over system 10.

Donor 12 and recipient 14 may perform these functions by accessing registry website 20. This feature allows recipient 14 and donor 12 to view and select financial instruments 22 at their leisure in their home or another private place. Recipient 14 and donor 12 do not have to visit a branch office thereby saving valuable time by viewing the gift registry options and the investment portfolio options on-line. Plus, recipient 14 and donor 12 may do so at any time during the day or night, eliminating the need to schedule appointments during normal business hours. By using registry website 20, recipient 14 and donor 12 are presented a more convenient way to register and fund a financial gift by using the disclosed embodiments, which provide easy access to a helpful range of financial planning topics and information.

Once all the steps are completed (disclosed in greater detail below), transaction process 28 is executed between donor 12 and broker 16 to fund gift account 27. Transaction process 28 may include a transfer of funds from donor 12 to gift account 27. Transaction process 28 occurs according to applicable laws and regulations, and using platforms/systems known to those skilled in the area of financial transactions.

Account activity and communication 26 is sent by broker 16 to donor 12 and recipient 14 to notify them that transaction process 28 occurred. Account activity and communication 26 also may refer to any activity taken after this initial process, such as reminders and the like. Account activity and communication 26 may refer to an email, message, or other electronic means of sending information to interested parties. Alternatively, account activity and communication 26 may refer to a statement provided to the interested parties. Account activity and communication 26 may differ from gift account 27 in that it pertains to information about gift account 27. Account activity and communication 26 also may include reminders, updates, statements, and the like.

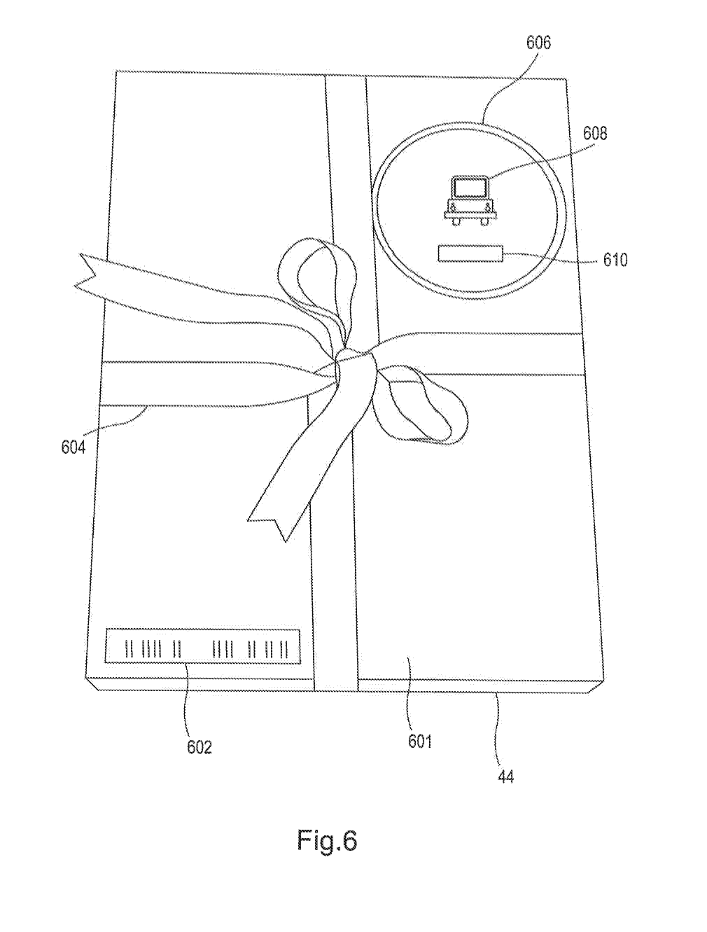

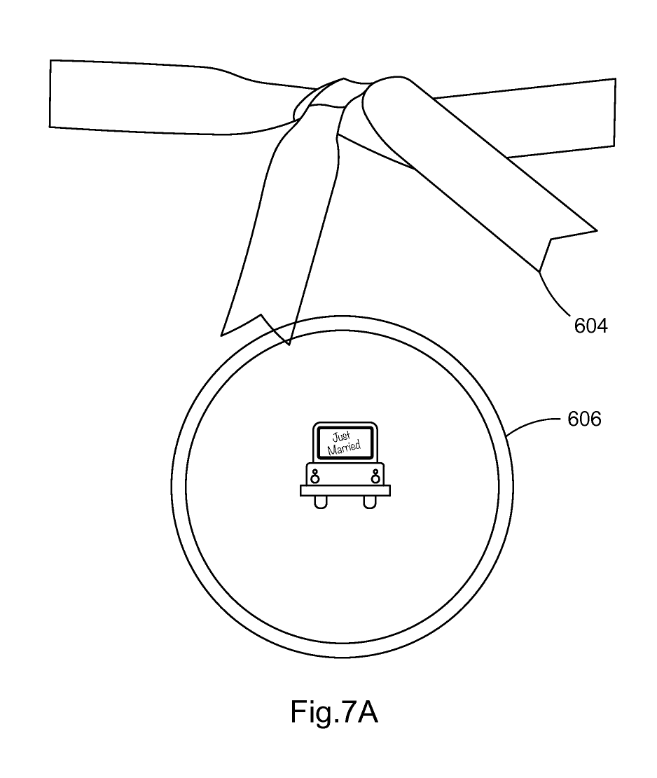

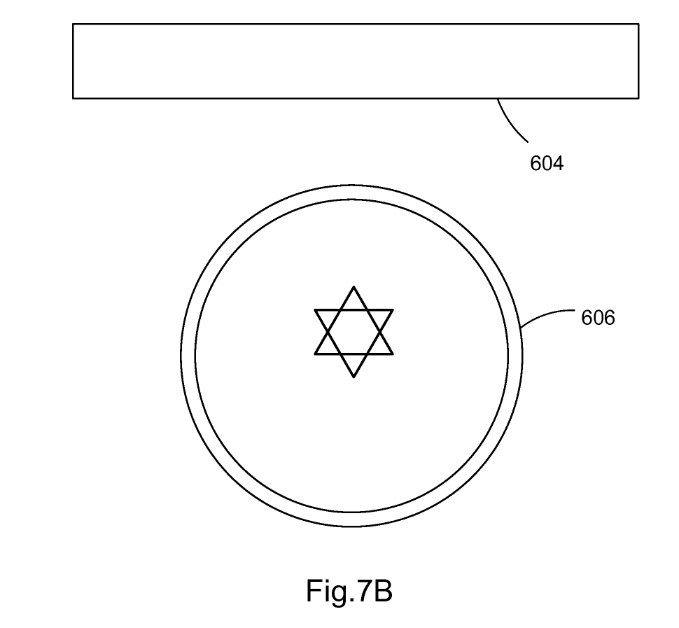

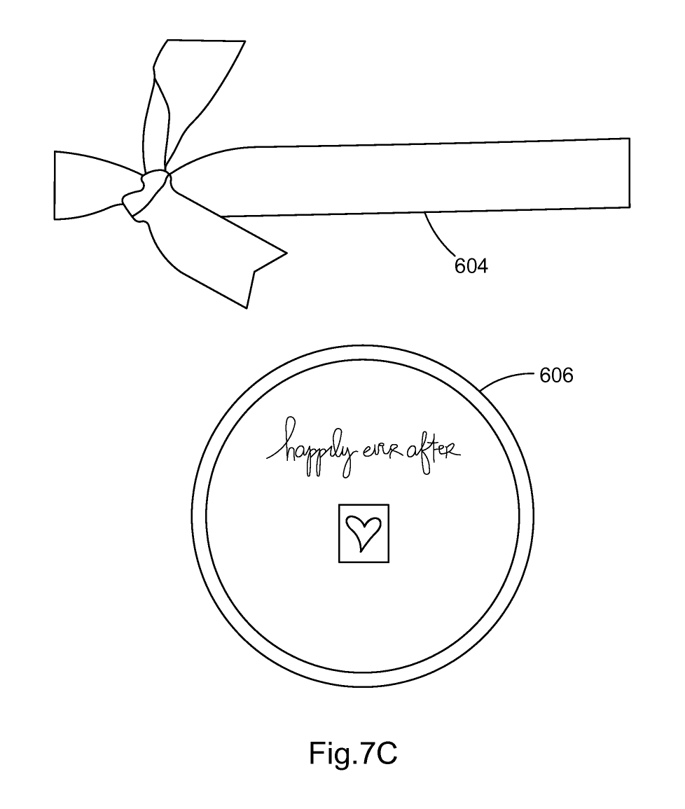

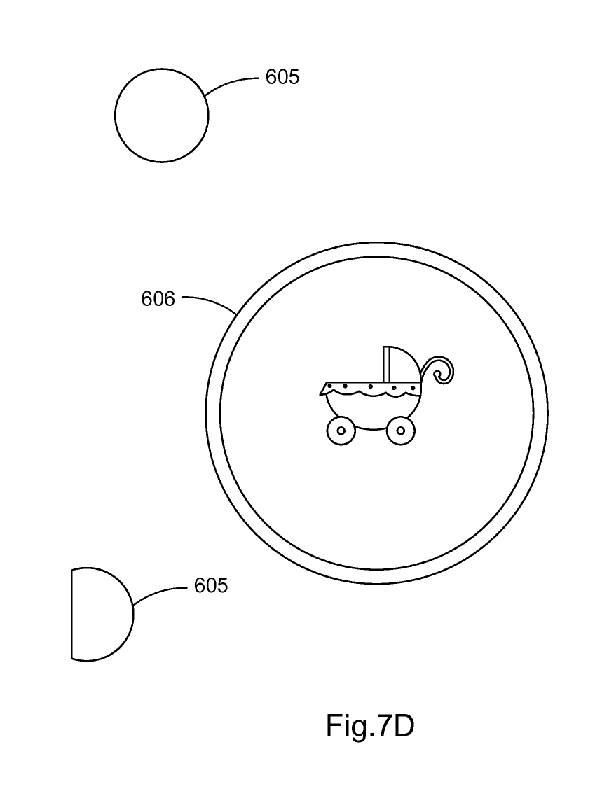

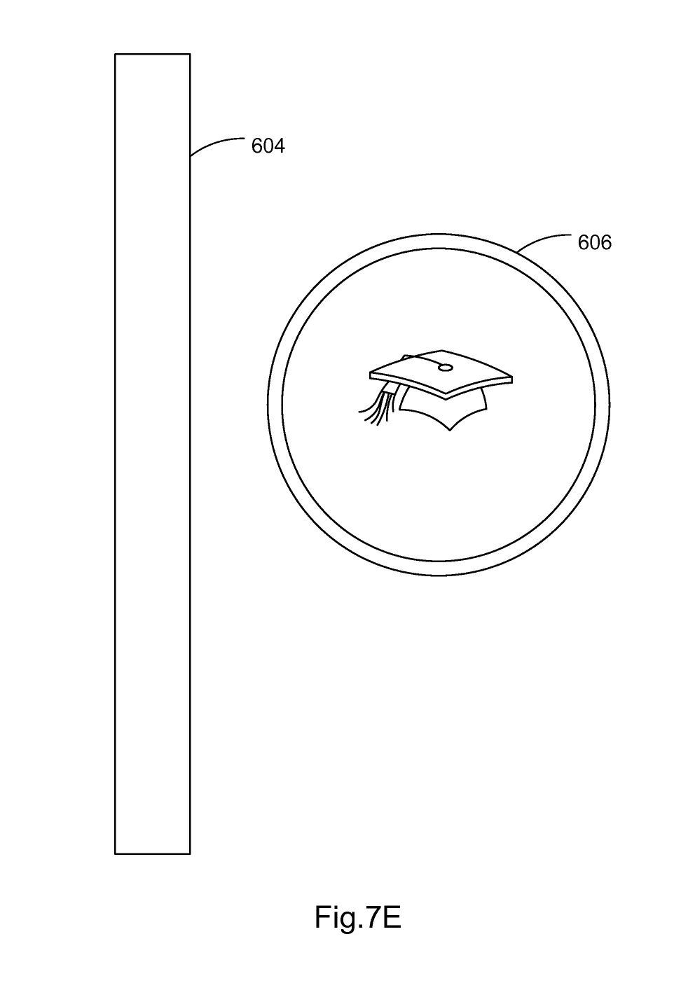

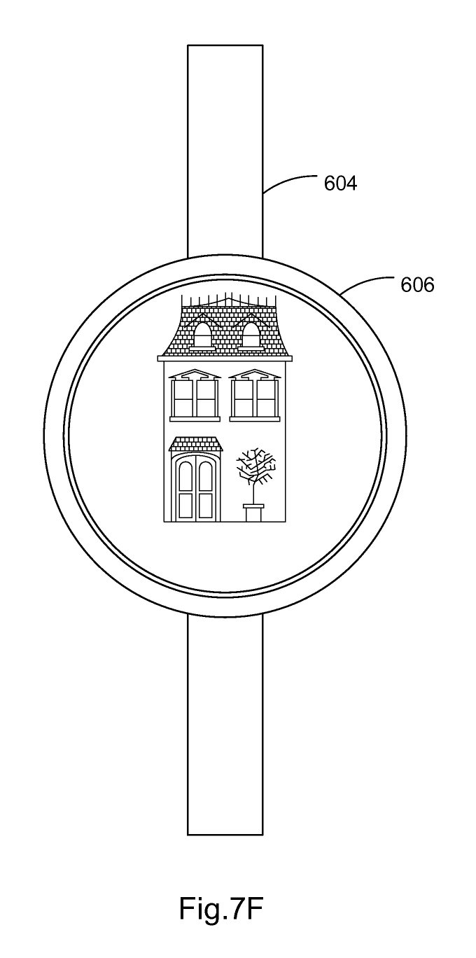

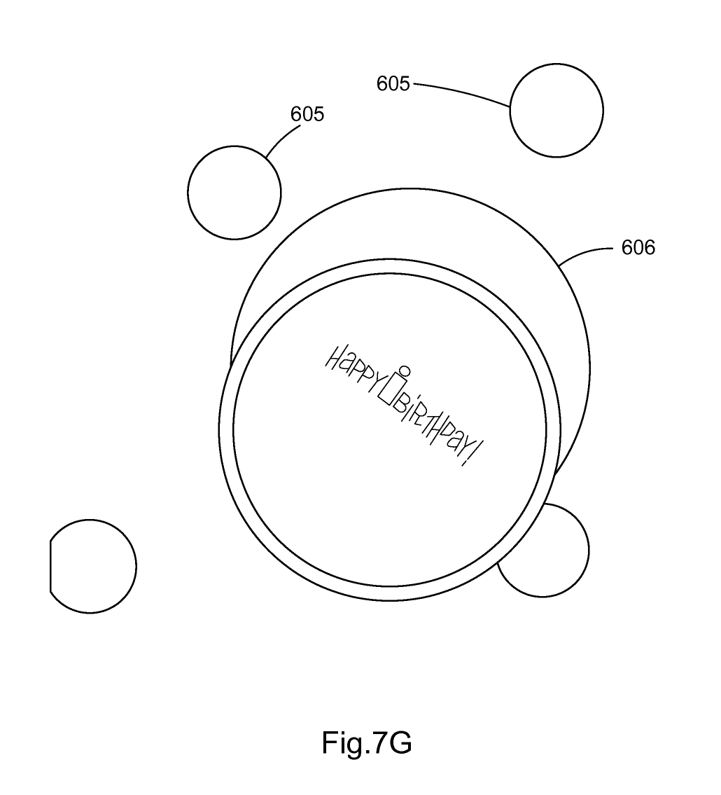

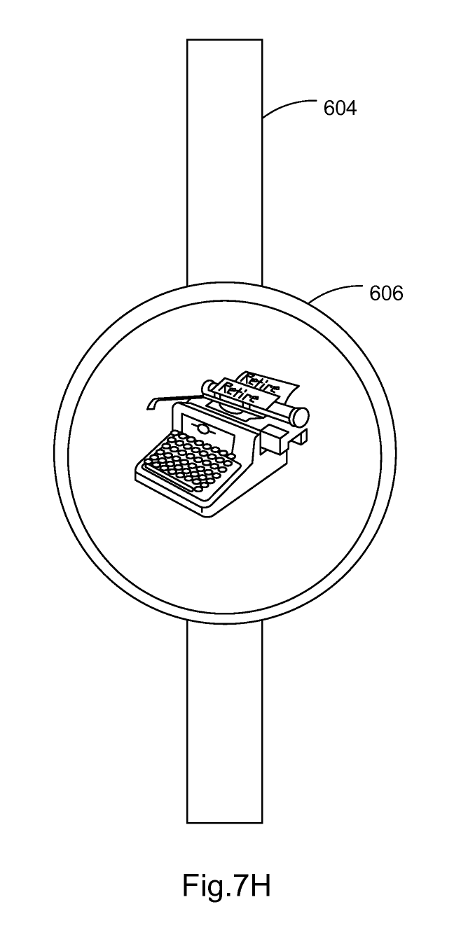

After all the desired information is collected, broker 16 or other service firm 18 may create gift fulfillment/confirmation package 44. Unlike the above accounts shown over computers, gift fulfillment/confirmation package 44 is a physical representation of the gift that is delivered to recipient 14. For example, gift fulfillment/confirmation package 44 may include a box resembling a traditional gift. Inside the box, written materials describing the selected financial instruments are provided as well as anything else to show that the recipient has received a “gift.” Contents and design of gift fulfillment package 44 may he derived from the selected financial instrument and the nature of the gift. Thus, pictures on the box and materials corresponding to the account inside the box may include a bride and groom for a wedding, a baby carriage for a birth, a cap and gown for a graduation, and the like. An example of a gift fulfillment/confirmation package 44 is provided below in FIG. 6. Pictures and designs generated as a result of the disclosed embodiments is shown in FIG. 7.

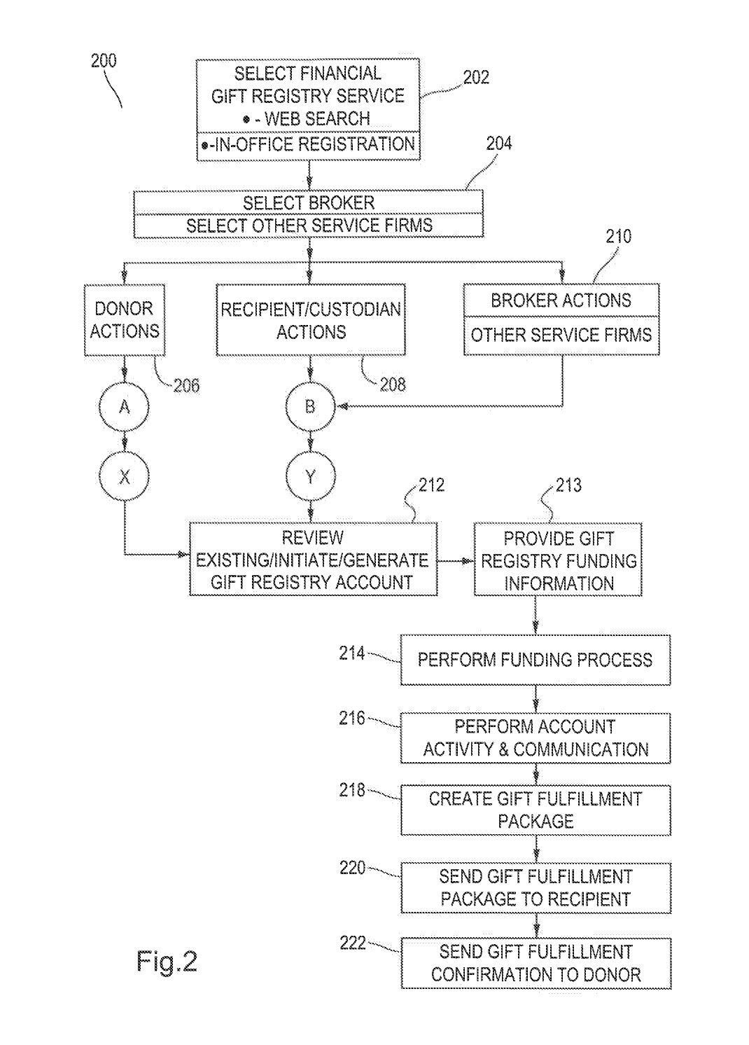

FIG. 2 depicts a flowchart 200 for a financial gift registry service according to the disclosed embodiments. FIG. 2 may refer back to elements shown in FIG. 1 for illustrative purposes only. FIG. 2 also may show actions performed by the different parties shown in FIG. 1, such as donor 12, recipient 14/custodian 15, and broker 16. These actions, however, are not limited to these parties and the steps shown in FIG. 2 may be performed by other entities of system 10.

Step 202 executes by selecting a financial gift registry service. This action may be performed by donor 12, recipient 14 or custodian 15. The entity may perform a web search using keywords or by exploring gift options. For example, donor 12 may search using the terms “financial gift registry” and receive links to various services. Alternatively, one may access another service firm such as a life stage media company having a well-known gift registry portal having a domain name related to the gift or event market (hereinafter “life stage gift portal”).

For example, recipient 14 may visit a well-known website providing on-line gift registry options, such as popular stores, brands, shopping malls, on-line retailers and the like. Along with these, various options for financial gift registration also are provided. Recipient 14 then may register these financial gifts along with the traditional gift registry activities. Thus, along with registering with well-known retailers, a recipient may register with a financial institution(s) and life stage media companies to provide financial gift registry services. A donor is directed to the service as opposed to selecting it from a list. In any event, the gift registry service is selected and the elements are directed to the processes disclosed in greater detail below.

Step 204 executes by selecting a broker or other service firm. A broker may refer to an individual, company, investment group and the like, as shown by broker 16 in FIG. 1. Preferably, the broker 16 is a well-known investment company, bank, or other service Finn 18 that has an association with a brokerage firm that may advise recipient 14 on investment opportunities and strategies and helps recipient 14 to open gift account 27. As disclosed above, one may select a well-known website, life stage portal, or service to facilitate gift registry actions. In addition to traditional gift registry items, such as housewares or clothes, the portal may include options for financial gifts. These are presented to a user, which then selects the disclosed service.

The various components (donor 12, recipient 14/custodian 15, broker 16) execute steps in completing the actions to open a gift account and to send a gift fulfillment package. These are disclosed below. Many of these steps may be performed by multiple components, such as recipient 14 with the help of broker 16. Further, the steps may be executed in conjunction with each other, and not necessarily in a certain order unless specified.

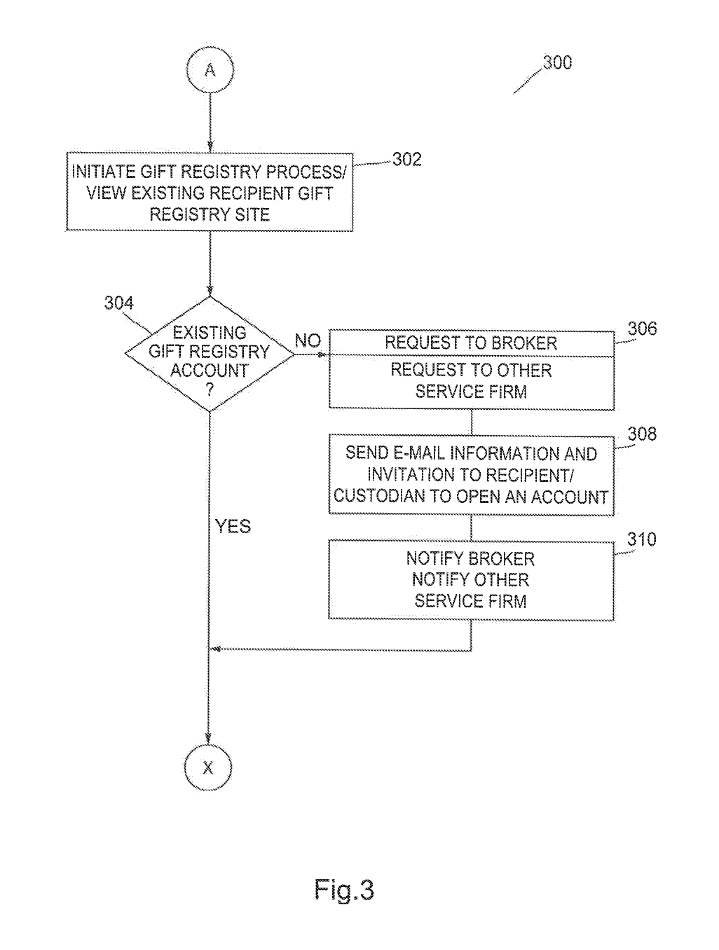

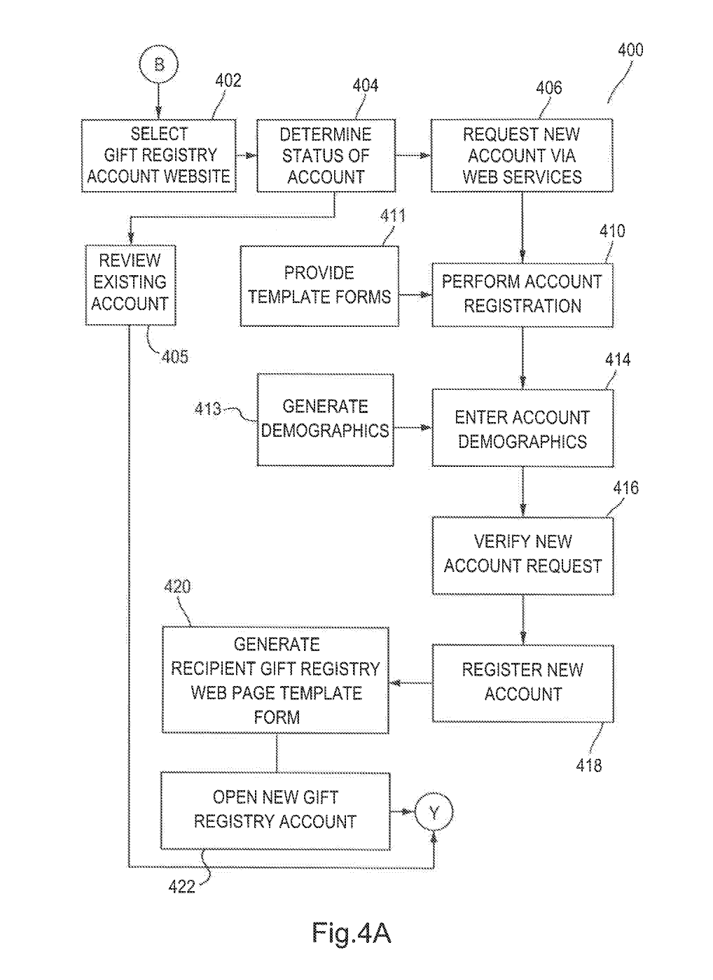

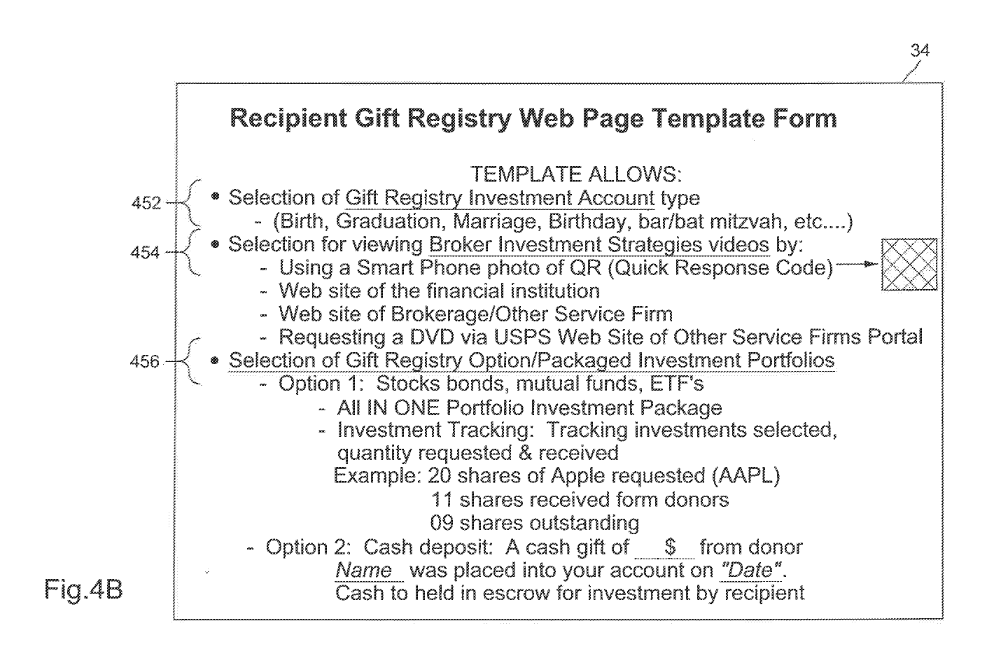

Thus, step 206 executes by performing donor actions and step 208 executes by performing recipient/custodian actions. These actions are disclosed in greater in FIGS. 3, 4A and 4B below. Broker 16 actions or other service firm 18 actions (hereinafter “broker actions”) of step 210 are also executed with the actions for the donor and the recipient/custodian. Thus, broker actions also flow to step B, but also may be included wherever indicated.

Flowchart 200 moves to step A from step 206 in FIG. 2 to perform donor actions. FIG. 3 depicts a flowchart 300 for performing donor actions according to the disclosed embodiments. Step A flows from FIG. 2 and continues to step 302. Step 302 executes by initiating the gift registry process or viewing an existing gift registry website by donor 12. For example, recipient 14 may configure a website 20 to list gift registry items of interest. Using this example, recipient 14 may list 5 mutual funds of interest for investment purposes. Donor 12 may view website 20 and select one of these mutual funds.

Step 304 executes by determining whether recipient 14 has an existing gift registry account 27. If yes, flowchart 300 proceeds back to step X to return the process back to FIG. 2, disclosed in greater detail below. The remaining donor actions occur in the steps shown in that figure.

If the answer to step 304 is no, then flowchart 300 moves to step 306. Step 306 executes by donor 12 requesting that broker 16, brokerage/bank or other service firm 18 contact recipient 14 or custodian 15 to open an account for the gift. Step 308 executes by sending an email with information and an invitation to recipient 14 or custodian 15 to open gift account 27 compliments of donor 12. Step 308 may be a broker action. The email may include a link directing recipient 14 or custodian 15 to contact broker 16. Step 310 executes by notifying broker 16, brokerage/bank or other service firm 18, of acceptance by recipient 14 or custodian 15. Donor 12 also may be notified. Flowchart 300 then returns the process back to step X and to FIG. 2.

Referring back to FIG. 2, recipient/custodian actions 208 and broker actions 210 proceed to step B. Step B continues to FIG. 4A, which depicts a flowchart 400 for performing recipient/custodian and broker actions according to the disclosed embodiments. Recipient 14 or custodian 15 and broker 16 may perform the actions needed to complete the steps disclosed below. For example, recipient 14 may meet broker 16 in an office setting to complete the opening of gift account 27. Alternatively, these events may occur in a virtual setting, which is especially convenient for broker 16 and recipient 14 (or custodian 15).

Step 402 executes by the selection of a gift registry account website 20 to be created. Recipient 14 or custodian 15 may do this. The selection may occur on a broker website or via a life stage gift portal. Recipient 14 may list stocks, certificates of deposit, mutual fund shares and the like that he or she would like to receive as gifts. Alternatively, the selection may be done in person with broker 16. Gift account website 20 may be associated with a specific event, such as a wedding, the birth of a child, a birthday, an anniversary, a graduation, a promotion, a retirement, bar/bat mitzvah, and the like.

Step 404 executes by determining the status of the account. “Status” may refer to whether the account is a new account for the recipient, a new account for a custodian for the benefit of the recipient or an existing account. For example, such a status may be determined by whether the age of actual recipient of the financial gift is less than 18. Using this example, if the actual recipient is under 18 years of age, then a custodian account will be opened. Other criteria may be specified for determining the status of the account. Alternatively, a recipient may appoint a custodian to register and manage gift account 27 on the recipient's behalf.

To avoid redundant language below, the disclosed embodiments will refer to recipient 14. The same actions performed by recipient 14 may be accomplished by a custodian 15.

Step 405 reflects the status that an account already exists for recipient 14. Thus, the disclosed embodiments may go directly to step Y. Recipient 14 and broker 16 may review the existing account and update it accordingly. Alternatively, flowchart 400 may proceed to any of the steps disclosed below from step 405 in the event recipient 14 wants to update or change the gift registry website or account.

Step 406 executes by requesting a new account via web services. Brokerage/bank 16 or other service firm 18 may receive the request and contact recipient 14. Step 410 executes by performing the account registration by recipient 14 and brokerage/bank 16 or other service firm 18. This step may be accomplished within an office or on-line with brokerage/bank 16 or other service firm 18 guiding recipient 14 through the process. Step 411 executes by providing template forms 34, and may be executed in conjunction with step 410. Forms 34 may be stored and accessible on system 10 by recipient 14 or broker 16. Thus, opening a new account may be done in person or via web services over system 10. This feature removes the need for in-office meetings with recipient 14 and broker 16, except when such meetings are necessitated by applicable laws and regulations.

Step 413 executes by generating demographics for recipient 14. Step 414 executes by entering these account demographics and an investment category for recipient 14. Brokerage/bank 16 or other service firm 18 may be involved in these steps by placing the information on the brokerage system. The demographics may include personal information of recipient 14, investment packages based on risk tolerance for recipient 14, and communication preferences. For example, the risk tolerance for someone graduating college is different than someone getting married, or close to retirement age. Further, recipient 14 may elect to receive notices or statements via email as opposed to regular mail.

Step 416 executes by verifying the new account request with recipient 14. Step 418 executes by registering the new account.

Step 420 executes by generating a recipient gift registry webpage template form, such as one from forms 34 shown in FIG. 1. This step is disclosed in greater detail by FIG. 4B. Template form 34 allows for steps 452-456 to be performed. Information may be entered onto a system using a computer or other device by recipient 14 or brokerage/bank 16 or other service firm 18.

Thus, step 452 executes by the selection of gift registry investment account type. For example, “type” may refer to the occasion or event pertaining to the gift, such as birth, graduation, marriage, birthday, bar/bat mitzvah, and the like. Step 454 executes by the selection for viewing of broker investment strategies videos by recipient 14 to receive information on what types of investment or financial instruments to choose. Other options may include receiving information from brokerage/bank 16 or other service firm 18. The videos may be prompted by using a smartphone scan of a quick response code, accessing a web site of the financial institution or the website of the other service firm, requesting a DVD for delivery, requesting a video file sent via email, using a social media site, and the like. This step allows brokerage/bank 16 or other service firm 18 to present informational and promotional materials on their services.

Step 456 executes by the selection of gift registry option/packaged investment portfolios by recipient 14 with brokerage/bank 16 or other service firm 18. Recipient 14 may choose from at least two options. Option 1 may include stocks, bonds, mutual funds, exchange traded funds, and the like. Examples are shown in FIG. 4B. Option 2 may include a cash deposit for later designation by recipient 14. As noted in FIG. 4B, the cash gift from donor 12 was placed into account 27 on the applicable date for use later.

Returning back to FIG. 4A, step 422 executes by opening the new gift registry account 27 according to the options and selections indicated by recipient 14. Brokerage/bank 16 or other service firm 18 helps in opening the new account, and issues the applicable account number along with any other information. Now that the account is opened, step Y returns flowchart 400 back to FIG. 2.

Now that account 27 is opened, step 212 executes by reviewing existing/initiating/generating gift registry account form. Preferably, this step is performed by donor 12 and broker 16, but also may be performed by recipient 14 and broker 16 should the recipient want to self-fund. This form allows the selection of the gift from the recipient gift registry request page, reflecting the information entered above. Step 213 executes by providing gift registry funding information. Thus, donor 12 may be presented with the financial gift registry request list, much like a traditional gift registry. This step also allows the selection of gift registry funding information, or how donor 12 will fund new account 27. Examples of funding include debit card, check, electronic transfer, mobile check using a mobile application, cash, and the like.

After all the above information is compiled, then step 214 executes by performing the funding process. The gift is deposited into new gift registry account 27. The funding process is a financial transaction, preferably between donor 12 and broker/brokerage firm/bank 16 or other service firm 18, in according with SEC regulations and guidelines.

Brokerage/bank 16 or other service firm 18 may use transaction process 28 to execute the transfer of funds to gift account 27. Transaction process 28 may be a trading platform for buying and selling financial instruments 22.

In step 214 for the gift funding process, completion of a financial transaction can be executed in four ways:

(1) donor 12 could request that brokerage/bank 16 or other service firm 18 deposit cash or an in-kind gift (shares of a mutual fund, stock, exchange traded fund and the like from an account for donor 12 into an account for recipient 14. In this way donor 12 can control what is purchased for recipient 14 by transferring, for example, 500 shares of stock to the account for recipient 14 Recipient 14 could sell it at any time. Donor 12 would be able to donate up to $13,000 a year to an individual as a gift tax deduction for the donor;

(2) donor 12 could deliver a check (personal or cashier's check) to the financial institution's branch office on behalf of recipient 14;

(3) donor 12 could fund gift account 27 by making a mobile deposit using a mobile application on their mobile device and the like; and

(4) recipient 14 could provide donor 12 with the account information in order for donor 12 to route money electronically either by wire or ACH transfer (electronic check).

Step 216 executes by performing account activity and communication with the parties. The key function is executing the trade on (lift registry account 27. This transaction is executed in accordance with exchange and SEC regulations and guidelines.

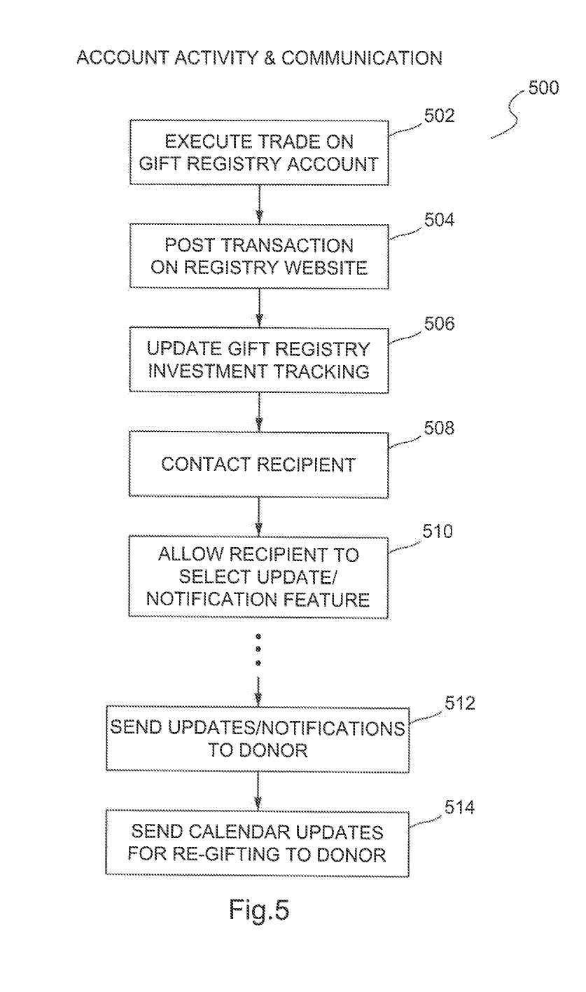

Step 216 may be broken into the steps disclosed in FIG. 5. FIG. 5 depicts a flowchart 500 of account activity and communication according to the disclosed embodiments. Step 502 executes by executing the trade on gift registry account 27 to receive the funds. Step 504 executes by posting the, transaction on gift registry website 20. Thus, this step may invoke an announcement message displayed. Step 506 executes by updating the gift registry investment tracking.

Step 508 executes by brokerage/bank 16 or other service firm 18 contacting recipient 14 in accordance with communication preferences noted in the account profile. Preferences may include email, regular mail, telegram, SMS service, instant message and the like. Step 510 executes by allowing recipient 14 to select an update/notification feature, in conjunction with this, step 512 executes by sending updates/notifications to donor 12, especially as activity occurs on gift account 27.

Step 514 executes by sending calendar updates for re-gifting account 27 to donor 12. Thus, donor 12 may be given alerts to fund additional gifts to the account. Updates may occur periodically, or when various life stage events are reached. For example, a gift account for a new baby may prompt donor 12 to re-gift as the child reaches significant graduation milestones (elementary, middle, junior or high school; college or university; graduate school along with yearly birthday notifications. Flowchart 500 then may return the disclosed embodiments back to flowchart 200.

Referring back to FIG. 2, step 216 proceeds to step 218. Step 218 executes by creating a gift fulfillment package 44 based on the gift registry account opened for recipient 14. The package may include an announcement or other materials wrapped as a traditional gift with details of the opened account, as well as a card from donor 12. Thus, not only does recipient 14 receive a new investment account, but also receives a complete package of investment portfolio materials with a more personal touch. The gift fulfillment package includes a coordinated folder and gift box set, which are designed for each specific occasion with the financial institution's or other service firm's name and logo printed on the cover of the folders and the gift box.

For example, package 44 may he designed with pink and blue-colored polka dots and a baby carriage design for the birth of a baby, the design of a car that has “just married” printed on it for a wedding, a design of a mortarboard for a graduate, a balloon design for a birthday and the like. In the folder, recipient 14 would find details of the financial gift registry investment portfolio account 27 (account applications and the like) and from website 20 (selected gift registry financial investment products and the like), a gift card from donor 12 including the amount the donor has funded, the investment, the donor's email and postal address for the recipient to send a thank you note and also a thank you note from broker 16. An example of a package 44 is shown in FIG. 6, disclosed in greater detail below.

Step 220 executes by sending a gift fulfillment package 44 to recipient 14 by broker 16. Thus, recipient 14 (or custodian 15 on behalf of recipient 14 receives a personalized gift box that commemorates the occasion and is more thoughtful than a card with cash or a check enclosed. The gift package is created based on the information entered for opening the account, disclosed above.

Step 222 executes by sending a gift fulfillment confirmation to donor 12. To encourage follow-up giving, donor 12 may receive reminders to further fund account 27 for recipient 14. The reminders may be periodic (he., yearly), or when life events occur. As the account is already opened, many of the steps disclosed above may be avoided.

FIG. 6 depicts an example of a gift fulfillment package 44 according to the disclosed embodiments. Package 44 is shown with a rectangular shape, but may be any shape, such as square, octagon, and the like. The shape also may reflect the occasion for the gift. Preferably, package 44 includes artistic gift wrapping 601. Again, the color of wrapping 601 may be tied to the occasion, such as pink and blue for the birth of a baby.

Package 44 also includes logo or name 602, preferably for brokerage/bank 16 or other service firm 18. Logo or name 602 indicates to recipient 14 that package 44 is not just a typical gift, but one pertaining to a financial gift. It also serves to promote broker 16 and its services or other service firm 18. Ribbon 604 may be wrapped around portions of package 44, and also coordinated with colors or logos coordinated with the above information.

Emblem 606 represents a portion of wrapping 601 that reflects information about the type of gift, reason for the gift, and the like. It serves to indicate to recipient 14 why he/she received the gift. Emblem 606 is shown as a circle, but may be any shape. Within emblem 606 is graphic 608 that further serves to identify the purpose of the gift. Various graphic designs may be used. The selection of the graphic design depends on the type of account chosen above. For example, FIG. 6 shows an automobile graphic as graphic 608. Although not shown, the words “Just Married” may be within a window on the graphic. An example of this embodiment is shown in FIG. 7a. This tells recipient 14 that this is a wedding gift. Box 610 may include a name, phrase, logo and the like to further identify the type of gift.

Thus, recipient 14 is presented with a professional and personal gift package 44 to reflect the opening of account 27 and funded by donor 12. Inside package 44 are materials, such as folders, about the account and brokerage/bank 16 or other service firm 18. Further, a card or other salutation from donor 12 may be included.

Folders and cards within package 44 also may include emblem 606 with graphic 608. This feature provides a coordinated and consistent visual presentation to recipient 14. Taking the information entered above in funding the gift account, the disclosed embodiments generate emblem 606 and graphic 608 along with information corresponding to broker 16 or other service firm 18. Emblem 606 is shown in the upper left corner of package 44, but may be located anyplace on package 44, or even be expanded to encompass the top. Emblem 44 may place on wrapping 601, or incorporated within the paper comprising wrapping 44.

FIG. 7A depicts examples of designs that may be used within emblem 606 as graphics. The design selected is based on the occasion for the financial gift, as entered above. Thus, FIG. 7A may represent a gift registry account opened for a marriage, wherein an automobile is shown having the words “Just Married” inside the back window. Emblem 606 is a circle with the graphic enclosed and offset from ribbon 604.

FIG. 7B may represent a gift registry account opened for a bar or bat mitzvah. Emblem 606 is a circle that encloses a graphic showing the Star of David to commemorate this Jewish tradition. The disclosed embodiments may celebrate other religious milestones, such as using a cross for confirmation or baptism. Ribbon 604 may appear simplified to denote the solemnity of the occasion.

FIG. 7C may represent a gift registry account opened for an engagement, a civil union, a marriage or anniversary. Emblem 606 includes a phrase denoting the occasion. In this instance, the phrase “happily ever after” is shown. Quotes, names, locations or any use of words may be placed into emblem 606 based upon the information collected in funding the gift registry account. A small graphic also may be included, as shown. Ribbon 604 may be offset from emblem 606.

FIG. 7D may represent a gift registry account opened for the birth of a baby. Pink and blue polka dots 605 may be used in the design of package 44 instead of ribbon 604. Polka dots 605 may denote a more festive atmosphere. Emblem 606 encloses a baby carriage. Alternative embodiments may include the baby's name.

FIG. 7E may represent a gift registry account opened for a graduation. The graphic within emblem 606 is a “cap” of the type usually worn by graduates during graduation ceremonies. Alternative embodiments may show a scroll or graphics for the specific degree, such as scales for law school. Ribbon 604 may be straight and offset from emblem 606.

FIG. 7F may represent a gift registry account opened for the purchase of a home. Emblem 606 encloses a graphic of a home. In this embodiment, emblem 606 is located on top of ribbon 604, which is straight.

FIG. 7G may represent a gift registry account opened for a birthday. The words “Happy Birthday!” are shown within emblem 606. Emblem 606 also uses a design that differs from others with a shaded area. Polka dots 605 also are used, but made to look like balloons for the birthday aspect. Alternatively, a graphic of a birthday cake may be used.

FIG. 7H may represent a gift registry account for a retirement. The graphic within emblem 606 is a typewriter showing a paper marked “Retire.” A sailboat or other graphic associated with retiring may be used. Emblem 606 is placed on top of ribbon 605.

It should be appreciated that the disclosed embodiments could be offered as a business method on a subscription or basis. For example, system 10 including transaction process 28 could he created, maintained or deployed by a service provider that offers the functions described herein for customers. A service provider could offer to deploy or provide the ability to process a logo and other content to generate a website using the disclosed processes.

In addition to being implemented as system and processes, the disclosed embodiments may be provided as a program product stored on a computer-readable medium, which, when executed, enables system 10 to generate gift account 27. To this extent, the computer-readable medium may include program code, which implements the processes and system disclosed herein. The term “computer-readable medium” includes one or more of any type of physical embodiment of the program code implementing the steps to execute the disclosed processes. In particular, the computer-readable medium can comprise program code embodied on one or more portable storage articles of manufacture, such as a compact disk, a DVD, a Blu-ray disk, a magnetic disk, a tape and the like, on one or more data storage portions of a computing device, such as a memory.

As used herein, the terms “program code” and “computer program code” are synonymous and refer to any expression, in any language, code or notation, of a set of instructions that cause a computing device having an information processing capability to perform a particular function either directly or after any combination of the following: (a) conversion to another language, code or notation; (h) reproduction in a different material form; or (c) decompression. To this extent, program code can be embodied as one or more types of program products, such as an application/software program, component software/library of functions, an operating system, a basic input/output system/driver for a particular computing or input/output device and the like. Terms such as “component” and “system” are synonymous as used herein and represent any combination of hardware or software capable of performing some function(s).

The block diagrams in the Figures illustrate the architecture, functionality and operation of possible implementations of system 10 and flowchart 200, plus possible computer program products. Each block in the block diagrams may represent a module, segment, or portion of code, which comprises one or more executable instructions for implementing the specified logical function(s). The functions noted in the blocks may occur out of order noted in the figures. For example, two blocks shown in succession may he executed substantially concurrently, or the blocks may sometimes be executed in the reverse order, depending upon the functionality involved. Each block of the block diagrams can be implemented by special purpose hardware-based systems that perform the specified functions or acts, or combinations of special purpose hardware and computer instructions.

It will be apparent to those skilled in the art that various modifications can be made to the disclosed embodiments of the financial gift registry system and associated methods without departing from the spirit or the scope of the invention. Thus, it is intended that the present invention covers the modifications to the disclosed embodiments provided that these modifications come within the scope of the following claims and their equivalents.

What is claimed is:

1. A method for using an on-line financial gift registry, the method comprising:
selecting gift registry options for a gift account by a recipient;
registering the account for the recipient by a broker;
completing a financial transaction by a donor and the broker to fund the gift account based on the selected gift registry options; and
sending a gift fulfillment package to the recipient by the broker, wherein the gift fulfillment package includes a design and at least one document corresponding to the gift account.

2. The method of claim 1, further comprising preparing the gift fulfillment package using the design.

3. The method of claim 1, wherein the recipient includes a custodian to represent the recipient when unable to perform the above steps.

4. The method of claim 1, wherein registering the account includes providing template forms to elicit information from the recipient or access an existing recipient account.

5. The method of claim 1, further comprising posting the gift registry options on a website corresponding to the recipient.

6. The method of claim 1, further comprising posting the financial transaction on a website.

7. The method of claim 1, further comprising sending an update or notification to the donor regarding the gift account.

8. The method of claim 1, further comprising sending a gift fulfillment confirmation to the donor.

9. The method of claim 1, further comprising viewing information regarding the gift registry options.

10. The method of claim 1, wherein the broker includes a bank, a brokerage or a service firm.

11. An on-line system for using a financial gift registry, the system comprising:
a website or web-enabled graphical user interface to select gift registry options for a gift account by a recipient and allow a donor to view the gift registry options; and
a gift fulfillment package that includes material corresponding to the account sent upon establishment of the gift account, wherein the gift fulfillment package includes a design corresponding to the gift account.

12. The system of claim 11, further comprising a broker to execute a financial transaction to fund the gift account.

13. The system of claim 12, wherein the broker includes a bank, brokerage firm or a service firm.

14. The system of claim 11, further comprising a custodian to perform tasks for when the recipient is unable.

15. The system of claim 11, wherein the gift fulfillment package includes an emblem with the design and a color corresponding the gift account.

16. A method for using an on-line financial gift registry, the method comprising:
displaying gift registry options for a plurality of financial instruments to a donor, wherein the gift registry options are selected by a recipient;
funding a gift account for the recipient based on one of the gift registry options; and
sending a gift fulfillment package for the gift account to the recipient.

17. The method of claim 16, further comprising preparing the gift fulfillment package using a design corresponding to an occasion identified by the recipient.

18. The method of claim 16, further comprising creating the gift account.

19. The method of claim 1, further comprising selecting a gift registry option by the donor, wherein the gift registry option relates to a financial instrument.

20. The system of claim 11, wherein the gift fulfillment package relates to a gift registry option selected by the donor.
